(19) United States
(12) Patent Application Publication
(10) Pub. No.: US 2023/0305376 A1
(43) Pub. Date: Sep. 28, 2023

(54) LIGHT SOURCE APPARATUS AND PROJECTOR

(71) Applicant: SEIKO EPSON CORPORATION, Tokyo (JP)

(72) Inventors: Shoichi UCHIYAMA, Suwa-gun Shimosuwa-machi (JP); Chigusa TAKAGI, Azumino-shi (JP); Tomoko AKAGAWA, Matsumoto-shi (JP); Tetsuo SHIMIZU, Matsumoto-shi (JP); Ryota TATSUMI, Chino-shi (JP)

(21) Appl. No.: 18/191,051

(22) Filed: Mar. 28, 2023

(30) Foreign Application Priority Data
Mar. 28, 2022 (JP) 2022-052358

(51) Int. Cl. G03B 21/20

(52) U.S. Cl. CPC G03B 21/204; G03B 21/2066; G03B 21/208

(57) ABSTRACT

A light source apparatus includes a first laser light emitter that emits first light, a wavelength converter that converts the first light into second light, a base including a first support part that supports the first laser light emitter, and a second support part that supports the wavelength converter, a light transmissive member that has first and second surfaces, the first light being incident on the first surface, a first reflector that is disposed at the second surface and reflects the first light toward the wavelength converter, and a light collection optical element that collects light emitted from the wavelength converter. A first distance along an optical axis of the light collection optical element between the wavelength converter and the light collection optical element is shorter than a second distance along the optical axis between the first laser light emitter and the light collection optical element.

The present application is based on, and claims priority from JP Application Serial Number 2022-052358, filed Mar. 28, 2022, the disclosure of which is hereby incorporated by reference herein in its entirety.

### BACKGROUND

### 1. Technical Field

The present disclosure relates to a light source apparatus and a projector.

### 2. Related Art

JP-A-2015-022954 discloses a light source apparatus in which excitation light is caused to incident from excitation light sources attached to an inclining portion of a seat on a phosphor provided in a recess of the seat, and fluorescence emitted from the phosphor is parallelized and extracted via a collimator lens.

JP-A-2012-054272 discloses a light source apparatus which includes a phosphor and excitation light sources provided at a support surface of a substrate and in which excitation light outputted from the excitation light sources in parallel to the support surface is caused to be incident on the phosphor, and fluorescence emitted from the phosphor is extracted via a light transmissive window.

The light source apparatus disclosed in JP-A-2015-022954, in which the phosphor is farther from the collimator lens than the excitation light sources, so that the collimator lens cannot capture part of the fluorescence emitted from the phosphor at a large angle of radiation, has a problem of a decrease in fluorescence extraction efficiency.

The light source apparatus disclosed in JP-A-2012-054272, in which the excitation light sources and the phosphor are disposed at the same support surface of the substrate, so that the heat of the excitation light sources and the phosphor increases the thermal density of the substrate, has a problem of a decrease in light emission efficiency due to an increase in the temperature of the phosphor and consequently a decrease in fluorescence extraction efficiency.

### SUMMARY

To solve the problems described above, a light source apparatus according to an aspect of the present disclosure includes a first laser light emitter configured to emit first light having a first wavelength band, a wavelength converter configured to convert the first light into second light having a second wavelength band different from the first wavelength band, a base including a first support part that supports the first laser light emitter and a second support part that supports the wavelength converter, a light transmissive member having a first surface and a second surface that is opposite from the first surface and disposed at a side opposite to the base with respect to the wavelength converter, the first light emitted from the first laser light emitter being incident on the first surface, a first reflector disposed at the second surface of the light transmissive member and configured to reflect the first light emitted from the first laser light emitter toward the wavelength converter, and a light collection optical element disposed at a second surface side of the light transmissive member and configured to collect light that is emitted from the wavelength converter and passes through the light transmissive member. A first distance along an optical axis of the light collection optical element between the wavelength converter and the light collection optical element is shorter than a second distance along the optical axis between the first laser light emitter and the light collection optical element.

A projector according to another aspect of the present disclosure includes the light source apparatus described above, a light modulator configured to modulate light emitted from the light source apparatus, and a projection optical apparatus configured to project the light modulated by the light modulator.

### BRIEF DESCRIPTION OF THE DRAWINGS

FIG. 1 shows a schematic configuration of a projector according to a first embodiment.

FIG. 2 is a schematic configuration diagram of an illuminator.

FIG. 3 is a plan view of a light source apparatus.

FIG. 4 is a cross-sectional view viewed in the direction of the arrows indicated by the line VI-VI in FIG. 3.

FIG. 5 is a perspective view showing the configuration of each laser light emitter.

FIG. 6 shows an excitation light irradiation spot formed on a first reflector.

FIG. 7A shows how fluorescence enters a light collection optical element in Comparative Example 1.

FIG. 7B shows how the fluorescence enters the light collection optical element in the embodiment.

FIG. 8A shows how the fluorescence enters the light collection optical element in Comparative Example 2.

FIG. 8B shows how the fluorescence enters the light collection optical element in Comparative Example 3.

FIG. 9 is a cross-sectional view showing key parts of the light source apparatus according to a second embodiment.

FIG. 10 is a cross-sectional view showing key parts of the light source apparatus according to a third embodiment.

FIG. 11 is a cross-sectional view of the light source apparatus according to a fourth embodiment.

FIG. 12 shows the configuration of a heat insulation wall according to a variation.

FIG. 13 shows the shape of a reflector according to a variation.

### DESCRIPTION OF EXEMPLARY EMBODIMENTS

Embodiments of the present disclosure will be described below in detail with reference to the drawings.

In the drawings used in the description below, a characteristic portion is enlarged for convenience in some cases for clarity of the characteristic thereof, and the dimension ratio and other factors of each component are therefore not always equal to actual values.

### First Embodiment

An example of a projector according to the present embodiment will be described.

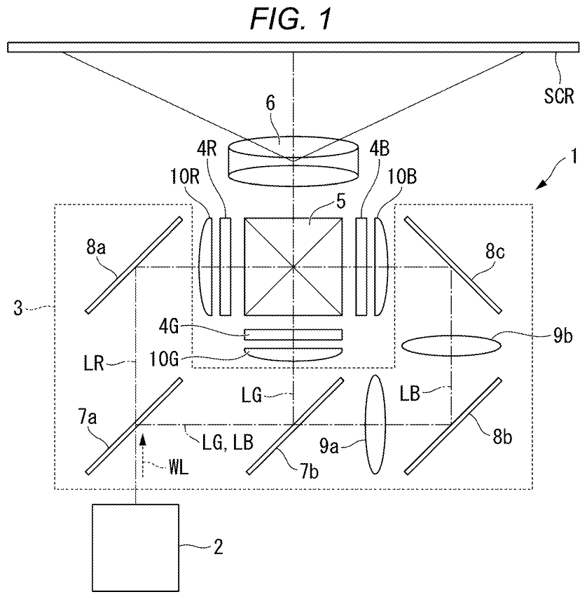

FIG. 1 shows a schematic configuration of the projector according to the present embodiment.

A projector 1 according to the present embodiment is a projection-type image display apparatus that displays color video images on a screen SCR, as shown in FIG. 1. The projector 1 includes a color separation system 3, light modulators 4R, 4G, and 4B, a light combining system 5, a projection optical apparatus 6, and an illuminator 2.

The color separation system 3 separates white illumination light WL from the illuminator 2 into red light LR, green light LG, and blue light LB. The color separation system 3 includes a first dichroic mirror 7a, a second dichroic mirror 7b, a first reflection mirror 8a, a second reflection mirror 8b, a third reflection mirror 8c, a first relay lens 9a, and a second relay lens 9b.

The first dichroic mirror 7a separates the illumination light WL from the illuminator 2 into the red light LR and the other light formed of the green light LG and the blue light LB. The first dichroic mirror 7a transmits the separated red light LR and reflects the separated other light. The second dichroic mirror 7b reflects the green light LG and transmits the blue light LB.

The first reflection mirror 8a reflects the red light LR toward the light modulator 4R. The second reflection mirror 8b and the third reflection mirror 8c guide the blue light LB to the light modulator 4B. The green light LG is reflected off the second dichroic mirror 7b toward the light modulator 4G.

The first relay lens 9a is disposed in the optical path of the blue light LB at the downstream of the second dichroic mirror 7b. The second relay lens 9b is disposed in the optical path of the blue light LB at the downstream of the second reflection mirror 8b.

The light modulator 4R modulates the red light LR in accordance with image information to form image light corresponding to the red light LR. The light modulator 4G modulates the green light LG in accordance with image information to form image light corresponding to the green light LG. The light modulator 4B modulates the blue light LB in accordance with image information to form image light corresponding to the blue light LB.

The light modulators 4R, 4G, and 4B are each, for example, a transmissive liquid crystal panel. Polarizers that are not shown are disposed at the light incident side and the light exiting side of each of the liquid crystal panels and configured to transmit only linearly polarized light polarized in a specific direction.

Field lenses 10R, 10G, and 10B are disposed at the light incident side of the light modulators 4R, 4G, and 4B, respectively. The field lenses 10R, 10G, and 10B parallelize the luminous fluxes of the red light LR, the green light LG, and the blue light LB to be incident on the respective light modulators 4R, 4G, and 4B.

The light combining system 5 receives the image light outputted from the light modulators 4R, 4G, and 4B, combines the image light corresponding to the red light LR, the image light corresponding to the green light LG, and the image light corresponding to the blue light LB with one another, and outputs the combined image light toward the projection optical apparatus 6. The light combining system 5 is, for example, a cross dichroic prism.

The projection optical apparatus 6 is formed of a plurality of lenses. The projection optical apparatus 6 enlarges the combined image light from the light combining system 5 and projects the enlarged image light toward the screen SCR. An image is thus displayed on the screen SCR.

### Illuminator

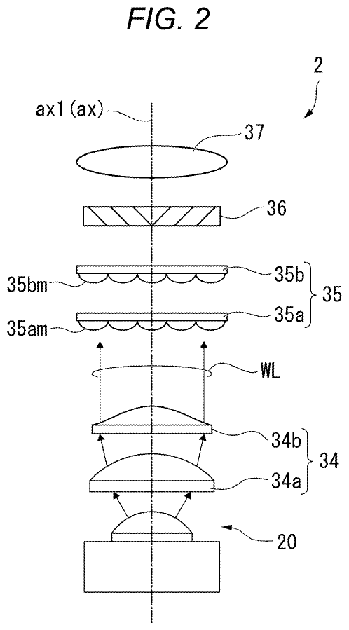

FIG. 2 is a schematic configuration diagram of the illuminator 2.

The illuminator 2 includes a light source apparatus 20, a pickup system 34, an optical integration system 35, a polarization converter 36, and a superimposing lens 37, as shown in FIG. 2.

The light source apparatus 20 outputs the white illumination light WL toward the pickup system 34.

The pickup system 34 is formed, for example, of pickup lenses 34a and 34b. The pickup system 34 has the function of picking up and parallelizing the illumination light WL outputted from the light source apparatus 20.

The illumination light WL parallelized by the pickup system 34 enters the optical integration system 35. The optical integration system 35 is formed, for example, of a first lens array 35a and a second lens array 35b.

The first lens array 35a includes a plurality of first lenslets 35am, and the second lens array 35b includes a plurality of second lenslets 35bm.

The first lens array 35a separates the illumination light WL into a plurality of thin pencils of light. The first lenslets 35am bring the thin pencils of light into focus at the corresponding second lenslets 35bm. The optical integration system 35 cooperates with the superimposing lens 37, which will be described later, to homogenize the illuminance distribution in image formation regions of the light modulators 4R and 4G shown in FIG. 1, which are illumination receiving regions.

The illumination light WL having passed through the optical integration system 35 enters the polarization converter 36. The polarization converter 36 is formed, for example, of polarization separation films and retardation films (half-wave plates). The polarization converter 36 converts the polarization directions of fluorescence YL into the polarization direction of one of the polarized components.

The illumination light WL having passed through the polarization converter 36 enters the superimposing lens 37. The illumination light WL having exited out of the superimposing lens 37 enters the color separation system 3. The superimposing lens 37 superimposes the plurality of thin pencils of light described above, which form the illumination light WL, on one another in the illumination receiving regions, that is, the image formation regions of the light modulators 4R and 4G so that the regions are uniformly illuminated.

The configuration of the light source apparatus 20 will be described below in detail.

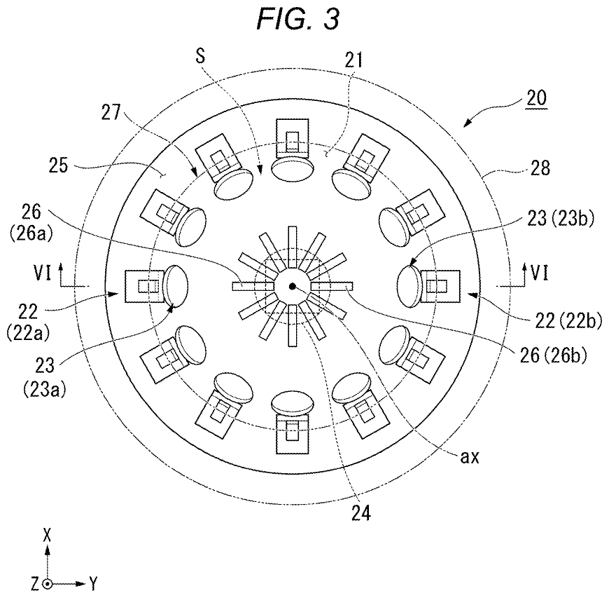

FIG. 3 is a plan view of the light source apparatus 20. FIG. 3 shows the light source apparatus 20 viewed in the direction along an optical axis ax (axis-Z direction).

In the drawings described below, each configuration of the light source apparatus 20 will be described by using an XYZ coordinate system as required. The axis Z is an axis parallel to the optical axis ax of the light source apparatus 20, and the axis X is an axis perpendicular to the optical axis ax and parallel to a normal to a base 21, which constitutes the light source apparatus 20. The axes Y and Z are perpendicular to each other and each perpendicular to the axis X. The optical axis ax of the light source apparatus 20 coincides with an illumination optical axis ax1 of the illuminator 2 shown in FIG. 2.

The light source apparatus 20 includes the base 21, a plurality of laser light emitters 22, a plurality of collimator lenses (parallelizing lenses) 23, a wavelength converter 24, a light transmissive member 25, a plurality of reflectors 26, a light collection optical element 27, and a side plate part 28, as shown in FIG. 3.

The light source apparatus 20 has a package structure in which the plurality of laser light emitters 22, the plurality of collimator lenses 23, and the wavelength converter 24 are housed in a space S, which is formed by the base 21, the side plate part 28, and the light transmissive member 25. The space S is desirably hermetically sealed. The plurality of laser light emitters 22 are disposed so as to surround the circumference of the wavelength converter 24.

The base 21 supports the plurality of laser light emitters 22, the plurality of collimator lenses 23, and the wavelength converter 24. The base 21 is, for example, a plate made of metal that excels in heat dissipation capability, such as aluminum and copper. The side plate part 28 forms a frame that surrounds the outer edge of the base 21, and supports the light transmissive member 25. The side plate part 28 protrudes beyond one surface of the base 21. The side plate part 28 has an annular shape in a plan view. The side plate part 28 maintains the distance (spacing) between the base 21 and the light transmissive member 25 constant. To this end, the side plate part 28 preferably has predetermined rigidity. The plan view refers to the state in which a target object is viewed in the direction along the optical axis ax of the light source apparatus 20 (axis-Z direction). In other words, the plan view refers to the state in which the target object is viewed in the direction along an optical axis 27C of the light collection optical element 27, which will be described later.

The side plate part 28 is preferably made of a material having a coefficient of linear expansion smaller than that of the base 21 but greater than that of the light transmissive member 25. The side plate part 28 is preferably made, for example, of Kovar or any other metal material, or alumina, silicon carbide, silicon nitride, or any other ceramic material, in particular, Kovar or alumina.

The light transmissive member 25 transmits light having exited out of the wavelength converter 24. The light transmissive member 25 has a circular shape in the plan view. Examples of the material of which the light transmissive member 25 is made may include borosilicate glass, quartz glass, synthetic quartz glass, and other glass materials, quartz crystal, and sapphire.

The side plate part 28 and the base 21, or the light transmissive member 25 and the side plate part 28 are joined to each other via a bonding material, such as an organic adhesive, a metallic bonding material, and an inorganic bonding material. The organic adhesive is preferably, for example, a silicone-based adhesive, an epoxy-based adhesive, and an acrylic-resin-based adhesive. The metallic bonding material is preferably, for example, silver braze and gold-tin solder. The inorganic bonding material is preferably, for example, low-melting-point glass.

In the plan view, the plurality of laser light emitters 22 are disposed along a circumference around the optical axis ax. The plurality of laser light emitters 22 are so disposed that each pair of laser light emitters face each other with the optical axis ax sandwiched therebetween.

In the present embodiment, the plurality of laser light emitters 22 include a first laser light emitter 22a and a second laser light emitter 22b. The first laser light emitter 22a and the second laser light emitter 22b are disposed on the base 21 so as to face each other with the optical axis ax sandwiched therebetween. The first laser light emitter 22a is disposed at a position shifted toward the side −Y from the optical axis ax, and the second laser light emitter 22b is disposed at a position shifted toward the side +Y from the optical axis ax.

In the plan view, the plurality of collimator lenses 23 are provided in correspondence with the plurality of laser light emitters 22. The collimator lenses 23 are each disposed between the corresponding laser light emitter 22 and light transmissive member 25 and parallelizes excitation light E outputted from the laser light emitter 22. The collimator lenses 23 may each be formed of a spherical lens. Since a spherical lens has no lens orientation, the burden of ensuring mounting accuracy is reduced and the mounting accuracy can be improved, so that there is no need to enlarge the reflectors 26 by a margin determined in consideration of variation in the mounting accuracy. The size of the reflectors 26 can thus be reduced.

The collimator lenses 23 may each instead be formed of a diffractive lens. Since a diffractive lens has a planar shape, the burden of ensuring the mounting accuracy is reduced, so that the same effects described above as those provided by a spherical lens can be provided.

In the present embodiment, the plurality of collimator lenses 23 include a first collimator lens 23a corresponding to the first laser light emitter 22a, and a second collimator lens 23b corresponding to the second laser light emitter 22b.

In the plan view, the plurality of reflectors 26 are radially disposed along a circumference around the optical axis ax. The reflectors 26 each have a rectangular shape extending in a direction perpendicular to the optical axis ax. The plurality of reflectors 26 are provided in correspondence with the plurality of laser light emitters 22. The reflectors 26 each have a reflection surface and reflects the light outputted from the corresponding laser light emitter 22 and parallelized by the corresponding collimator lens 23. In the present embodiment, the plurality of reflectors 26 include a first reflector 26a corresponding to the first laser light emitter 22a, and a second reflector 26b corresponding to the second laser light emitter 22b. In the present embodiment, the first reflector 26a and the second reflector 26b are separate members and are spaced from each other.

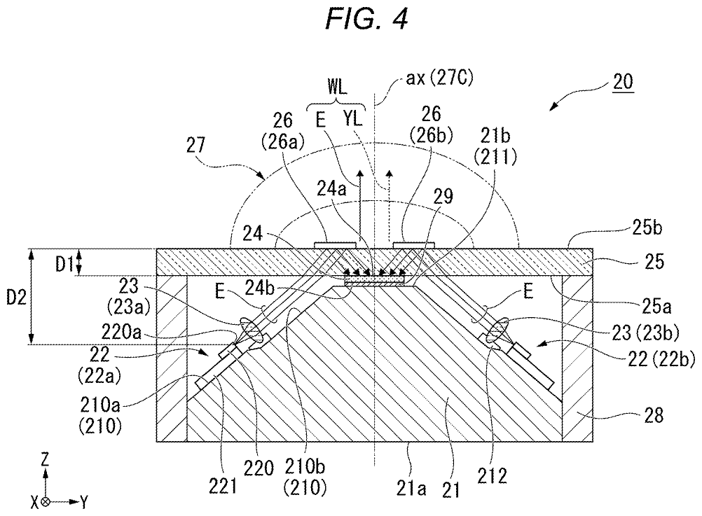

FIG. 4 is a cross-sectional view of the light source apparatus 20. FIG. 4 shows a cross section viewed in the direction of the arrows indicated by the line VI-VI in FIG. 3 and is a cross-sectional view of the light source apparatus 20 taken along a plane including the optical axis ax and perpendicular to the plane XY. Note that FIG. 4 is a cross-sectional view showing the first laser light emitter 22a and the second laser light emitter 22b out of the plurality of laser light emitters 22.

The base 21 has a rear surface 21a and a front surface 21b facing away from the rear surface 21a, as shown in FIG. 4. The front surface 21b is shifted toward the light transmissive member 25 from the rear surface 21a. The rear surface 21a and the front surface 21b are parallel to each other, and the planar area of the front surface 21b is smaller than the planar area of the rear surface 21a. The cross section of the base 21 taken along a plane including the optical axis ax and perpendicular to the plane XY has a substantially inverted V shape. The cross-sectional shape of the base 21 taken along a plane including the optical axis ax of the base 21 and perpendicular to the plane XY is symmetrical around the optical axis ax.

The base 21 includes a first support part 210, which supports the plurality of laser light emitters 22 including the first laser light emitter 22a and the second laser light emitter 22b, and a second support part 211, which supports the wavelength converter 24.

The laser light emitters 22 are thermally coupled to the base 21 via the first support part 210, and the wavelength converter 24 is thermally coupled to the base 21 via the second support part 211. That is, the base 21 functions as a heat dissipation member that dissipates heat of the laser light emitters 22 and the wavelength converter 24.

The first support part 210 has a light emitter support surface 210a, which supports the laser light emitters 22, and a lens support surface 210b, which supports the collimator lenses 23.

The light emitter support surface 210a is a surface inclining with respect to the rear surface 21a and the front surface 21b of the base 21. The light emitter support surface 210a is an inclining surface that approaches the optical axis ax when extending from the rear surface 21a toward the front surface 21b.

The lens support surface 210b is a portion, of the light emitter support surface 210a, that is shifted toward the light transmissive member 25. The lens support surface 210b is a surface recessed toward the optical axis ax from the light emitter support surface 210a, and supports the collimator lenses 23 via lens holders 212.

The second support part 211 is provided at the front surface 21b, which forms the top portion of the base 21, which has an inverted V shape.

The configuration of the laser light emitters 22 will be subsequently described. The laser light emitters 22 have the same configuration.

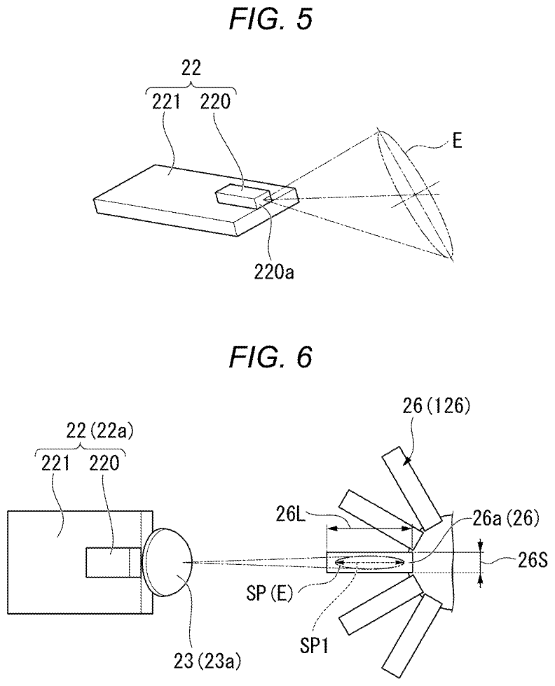

FIG. 5 is a perspective view showing the configuration of each of the laser light emitters 22.

The laser light emitters 22 each include a light emitting part 220 and a sub-mount 221, as shown in FIG. 5. The light emitting part 220 has an oblong light emission surface 220a, via which the excitation light (first light) E having a first wavelength band is emitted. The first wavelength band is, for example, a blue-violet wavelength band ranging from 400 to 480 nm and has a peak wavelength of, for example, 455 nm.

The cross section, of the excitation light E outputted from each of the laser light emitters 22, that is perpendicular to the chief ray of the excitation light E has an elliptical shape. The direction of the major axis of the elliptical shape coincides with the widthwise direction of the light emission surface 220a (direction in which light emitting part 220 and sub-mount 221 are layered on each other). The excitation light E outputted from each of the laser light emitters 22 does not necessarily have a perfect elliptical cross-sectional shape.

The sub-mount 221 is made, for example, of a ceramic material, such as aluminum nitride and alumina. The sub-mount 221 mitigates thermal stress induced by the difference in the coefficient of linear expansion between the base 21 and the light emitting part 220. The sub-mount 221 is bonded to the first support part 210 of base 21 via a bonding material, such as silver graze and gold-tin solder.

Based on the configuration described above, the laser light emitters 22 are each configured to output the excitation light E toward the light transmissive member 25. Since the excitation light E outputted from the laser light emitters 22 behaves in the same manner in the light transmissive member 25, the behavior of the excitation light E outputted from the first laser light emitter 22a will be described below by way of example.

The excitation light E outputted from the first laser light emitter 22a enters the corresponding first collimator lens 23a, as shown in FIG. 4. The first collimator lens 23a parallelizes the excitation light E. The excitation light E parallelized by the first collimator lens 23a enters the light transmissive member 25.

The light transmissive member 25 has a first surface 25a and a second surface 25b. The first surface 25a of the light transmissive member 25 is a surface that faces the base 21. The second surface 25b of the light transmissive member 25 is a surface opposite from the first surface 25a, and is a light exiting surface via which the light from the wavelength converter 24 exits. The light transmissive member 25 is disposed at the side across the wavelength converter 24 from the base 21, and the excitation light E outputted from the first laser light emitter 22a is incident on the first surface 25a. The light transmissive member 25 and the wavelength converter 24 may be in contact with each other, or may have a gap provided therebetween. In the present embodiment, the configuration in which the light transmissive member 25 and the wavelength converter 24 are in contact with each other allows the heat of the wavelength converter 24 to be dissipated via the light transmissive member 25. When the light transmissive member 25 and the wavelength converter 24 are in contact with each other, the light transmissive member 25 is desirably made of a material having high thermal conductivity, such as sapphire.

The excitation light E outputted from the first laser light emitter 22a is refracted at the first surface 25a, enters the light transmissive member 25, passes through the interior thereof, and is incident on the first reflector 26a disposed at the second surface 25b. The first reflector 26a reflects the excitation light E outputted from the first laser light emitter 22a toward the wavelength converter 24.

The excitation light E has the elliptical cross-sectional shape, as shown in FIG. 5, and therefore forms an elliptical irradiation spot on each of the reflectors 26. In the present embodiment, the excitation light E is incident on each of the reflectors 26 in an oblique direction and therefore forms a more elongated elliptical irradiation spot on the reflector 26.

In the light source apparatus 20 according to the present embodiment, the reflectors 26 are each provided in the region, of the second surface 25b of the light transmissive member 25, on which the excitation light E outputted from the corresponding laser light emitter 22 is incident.

FIG. 6 shows the excitation light irradiation spot formed on the first reflector.

The first reflector 26a has a rectangular planar shape having a lengthwise dimension 26L and a widthwise dimension 26S, and the excitation light E forms an elliptical irradiation spot SP on the first reflector 26a, as shown in FIG. 6. In the present embodiment, the first laser light emitter 22a and the first reflector 26a are so disposed that a major axis SP1 of the irradiation spot SP extends along the lengthwise dimension 26L of the first reflector 26a. That is, the first reflector 26a is provided at the second surface 25b of the light transmissive member 25 in correspondence with the irradiation spot SP of the excitation light E outputted from the corresponding first laser light emitter 22a. The irradiation spot SP is thus unlikely to extend off the first reflector 26a, whereby the first reflector 26a efficiently allows the excitation light E to enter the wavelength converter 24. The planar shape of each of the reflectors is the planar shape of the reflection surface of the reflector viewed in the direction perpendicular to the reflective surface.

In FIG. 6, the first reflector 26a has been presented by way of example, and the same holds true for the irradiation spot formed on the second reflector 26b by the excitation light E outputted from the second laser light emitter 22b, and the irradiation spots formed on the reflectors 26 by the laser light emitters 22 that correspond thereto.

In the light source apparatus 20 according to the present embodiment, the reflectors 26 can be selectively disposed in the regions, of the second surface 25b of the light transmissive member 25, on which the excitation light E outputted from the laser light emitters 22 is incident.

The reflectors 26 preferably have a wavelength characteristic that causes selective reflection of light having the wavelength band of the excitation light E. In the present embodiment, the reflectors 26 are each formed of a dichroic mirror (optical element) 126, which reflects the excitation light E having the first wavelength band and transmits the fluorescence YL having a second wavelength band. The reflectors 26 each preferably have an incidence angle characteristic that provides relatively high reflectance for the angle of incidence of the excitation light E and relatively low reflectance for other angles of incidence.

The wavelength converter 24 has a light incident surface 24a, on which the excitation light E is incident, and a rear surface 24b, which is opposite from the light incident surface 24a. The rear surface 24b of the wavelength converter 24 is supported by the second support part 211 of the base 21. A reflection mirror 29 is provided between the rear surface 24b of the wavelength converter 24 and the second support part 211 (front surface 21b).

The wavelength converter 24 contains a phosphor that converts the excitation light E into the fluorescence (second light) YL, which has the second wavelength band different from the first wavelength band. The second wavelength band is, for example, a yellow wavelength band ranging from 550 to 640 nm. The phosphor can, for example, be an yttrium-aluminum-garnet-based (YAG-based) phosphor. The phosphor may be made of one type of material, or a mixture of particles made of two or more materials may be used as the phosphor.

The fluorescence YL, into which the excitation light E incident via the light incident surface 24a has been converted, and the excitation light E that has not been converted into the fluorescence exit via the light incident surface 24a of the wavelength converter 24. The excitation light E that has not been converted into the fluorescence includes the component that has been reflected off the front surface of the wavelength converter 24 as well as the component that has not been converted into the fluorescence in the phosphor.

In the wavelength converter 24, part of the excitation light E and the fluorescence YL travels toward the rear surface 24b. In the present embodiment, the reflection mirror 29 provided between the rear surface 24b and the second support part 211 can reflect the fluorescence YL and the excitation light E toward the light incident surface 24a.

Based on the configuration described above, the wavelength converter 24 in the present embodiment allows the white illumination light WL including the fluorescence YL and part of the excitation light E to exit via the light incidence surface 24a.

The illumination light WL having exited out of the wavelength converter 24 passes through the light transmissive member 25 and enters the light collection optical element 27. Part of the illumination light WL is incident on the reflectors 26, which are formed at the second surface 25b of the light transmissive member 25. The reflectors 26, which are each formed of a dichroic mirror 126, which transmits the fluorescence YL and reflects the excitation light E, transmit the fluorescence YL contained in the illumination light WL and reflect the excitation light E contained in the illumination light WL.

In the light source apparatus 20 according to the present embodiment, the reflectors 26 are selectively disposed at the second surface 25b of the light transmissive member 25 at the positions where the excitation light E is incident (irradiation spots SP), so that the region on which the excitation light E is not incident transmits light regardless of the wavelength band thereof.

The excitation light E contained in the illumination light WL therefore exits toward the light collection optical element 27 through the gaps between the plurality of reflectors 26. The gaps between the reflectors 26 mean the portions between reflectors 26 adjacent to each other along a circumference around the optical axis ax and the portions between the pairs of reflectors 26 facing each other with the optical axis ax sandwiched therebetween. The light source apparatus 20 according to the present embodiment allows reduction in the amount of loss of the excitation light E due to the reflection off the reflectors 26 and can therefore efficiently generate the white illumination light WL.

The light collection optical element 27 is disposed at the side facing the second surface 25b of the light transmissive member 25, and collects the illumination light WL having exited out of the wavelength converter 24 and passed through the light transmissive member 25 to narrow the luminous flux width of the illumination light WL. In the present embodiment, the light collection optical element 27 may be provided so as to be in contact with or separate from the second surface 25b of the light transmissive member 25. The light collection optical element 27 in the present embodiment is formed of a meniscus lens having a light incident surface formed of a concave surface and a light exiting surface formed of a convex surface. The light collection optical element 27 may not be a meniscus lens.

Out of the illumination light WL having exited out of from the wavelength converter 24, the fluorescence YL exits at a large angle of radiation. To efficiently collect the fluorescence YL having exited at the large angle of radiation and transmit the collected fluorescence YL to a downstream optical system, a lens on which the fluorescence YL having exited out of the wavelength converter 24 is incident needs to be disposed in the vicinity of the wavelength converter 24.

The effects of the light source apparatus 20 according to the present embodiment will be described in comparison with a light source apparatus in which the light transmissive member 25 is omitted and the light collection optical element 27 is disposed in the vicinity of the wavelength converter 24. To simplify the description of the configuration of the light source apparatus according to Comparative Example, it is assumed that how the excitation light enters the wavelength converter 24 is not considered.

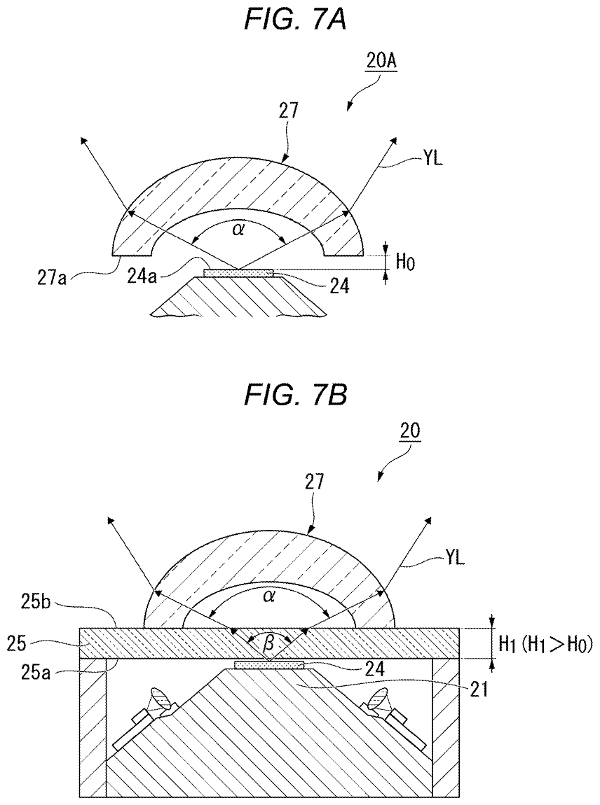

FIG. 7A shows how the fluorescence YL enters the light collection optical element 27 in a light source apparatus 20A according to Comparative Example 1. FIG. 7B shows how the fluorescence YL enters the light collection optical element 27 in the light source apparatus 20 according to the present embodiment.

In the light source apparatus 20A according to Comparative Example 1 shown in FIG. 7A, in which the light transmissive member 25 is not provided, the light collection optical element 27 can be disposed in the vicinity of the wavelength converter 24. Therefore, in the light source apparatus 20A, the fluorescence Y having exited out of the wavelength converter 24 at a large angle of radiation α can be collected by the light collection optical element 27 to be captured by a downstream optical system. In the light source apparatus 20A according to Comparative Example 1 shown in FIG. 7A, let H₀ be the distance from the light incident surface 24a of the wavelength converter 24 to the light collection optical element 27.

On the other hand, in the light source apparatus 20 according to the present embodiment shown in FIG. 7B, the light transmissive member 25 is disposed between the wavelength converter 24 and the light collection optical element 27. Now, let H₁ be the thickness of the light transmissive member 25. Compare the thickness H₁ of the light transmissive member 25 with the distance H₀ from the light incident surface 24a of the wavelength converter 24 to an end surface 27a of the light collection optical element 27, which is the surface closest to the wavelength converter 24, in the light source device 20A according to Comparison Example 1, and H₁>H₀ is satisfied. Since the refractive index of the light transmissive member 25 is greater than one, the air equivalent length of the thickness H₁ is smaller than the actual dimension of thickness H₁. The air equivalent length of the thickness H₁ can therefore be regarded approximately equal to the distance H₀ in Comparative Example 1. That is, light that exits at the angle of radiation α in air behaves as light that exits at a smaller angle of radiation β in the light transmissive member 25.

The light source apparatus 20 according to the present embodiment, in which the light transmissive member 25 suppresses spreading of the fluorescence YL, therefore allows the light collection optical element 27 to capture the fluorescence YL that exits at the angle of radiation α in air as in the light source apparatus 20A according to Comparative Example 1. The light source apparatus 20 according to the present embodiment therefore, in which the light transmissive member 25 is disposed between the wavelength converter 24 and the light collection optical element 27, allows the fluorescence YL to be utilized as efficiently as in the light source apparatus 20A according to Comparative Example 1, in which the light collection optical element 27 is disposed in the vicinity of the wavelength converter 24.

In the light source apparatus 20 according to the present embodiment, a first distance D1 along the optical axis 27C of the light collection optical element 27 between the wavelength converter 24 and the light collection optical element 27 is shorter than a second distance D2 along the optical axis 27C between the first laser light emitter 22a and the light collection optical element 27, as shown in FIG. 4. The optical axis 27C of the light collection optical element 27 is an axis that extends along the axis Z and coincides with the optical axis ax of the light source apparatus 20. In the present embodiment, the first distance D1 is specified by the distance from the light incident surface 24a of the wavelength converter 24 to the end surface 27a of the light collection optical element 27, which is the surface closest to the wavelength converter 24. The second distance D2 is specified by the distance from the center of the light emission surface 220a of the first laser light emitter 22a to the end surface 27a of the light collection optical element 27.

An effect of the light source apparatus 20 according to the present embodiment in which the first distance D1 described above is shorter than the second distance D2 described above will be described in comparison with the light source apparatuses according to Comparative Examples in which the second distance D2 is shorter than the first distance D1.

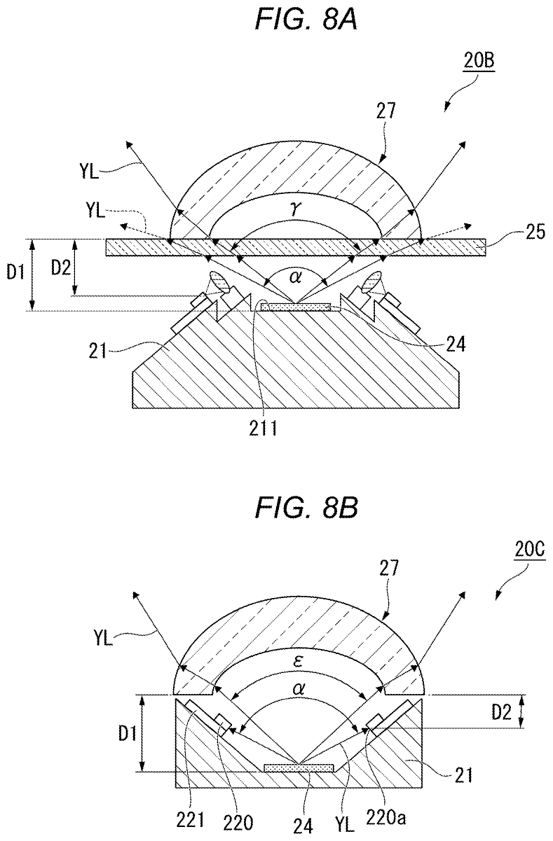

FIG. 8A shows how the fluorescence YL enters the light collection optical element 27 in a light source apparatus 20B according to Comparative Example 2. FIG. 8B shows how the fluorescence YL enters the light collection optical element 27 in a light source apparatus 20C according to Comparative Example 3.

The light source apparatus 20B according to Comparative Example 2 differs in configuration from the light source apparatus 20 according to the present embodiment in that the second support part 211, which supports the wavelength converter 24, is provided in a recess formed at the top of the base 21, as shown in FIG. 8A. In the light source apparatus 20B according to Comparative Example 2, in which the laser light emitters 22 are disposed between the wavelength converter 24 and the light collection optical element 27, the first distance D1 is longer than the second distance D2.

The light collection optical element 27 cannot therefore capture fluorescence components having exited at angles of radiation larger than the angle of radiation a, at which the fluorescence YL has exited out of the wavelength converter 24. That is, the light source apparatus 20B according to Comparison Example 2, in which the light collection optical element 27 can capture only the fluorescence YL having exited at an angle of radiation γ, which is smaller than the angle of radiation α, has efficiency of utilization of the fluorescence YL lower than that of the light source apparatus 20 according to the present embodiment. Furthermore, the fluorescence components that are not captured by the light collection optical system 27 may be absorbed by other optical parts in the light source apparatus and generate unwanted heat.

The light source apparatus 20C according to Comparative Example 3 differs in configuration from the light source apparatus 20 according to the present embodiment in that the light transmissive member 25 is not used, and that the excitation light E directly enters the wavelength converter 24 disposed at the center of the base 21 from the surroundings of the wavelength converter 24, as shown in FIG. 8B. In the light source apparatus 20C according to Comparative Example 3, the light emission surface 220a of each of the laser light emitters 22 is shifted toward the light collection optical element 27 from the support surface of the wavelength converter 24. Therefore, in the light source apparatus 20C according to Comparative Example 3, in which the laser light emitters 22 are disposed between the wavelength converter 24 and the light collection optical element 27, the first distance D1 is longer than the second distance D2, as in the light source apparatus 20B according to Comparative Example 2.

The light source apparatus 20C according to Comparative Example 3, in which the light collection optical element 27 can capture only the fluorescence YL having exited at an angle of radiation ε, which is smaller than the angle of radiation α, therefore has efficiency of utilization of the fluorescence YL lower than that of the light source apparatus 20 according to the present embodiment. In practice, in the light source apparatus 20C, the light collection optical element 27 cannot capture the fluorescence YL having exited at the angle of radiation α, which is blocked by the base 21.

In the light source apparatus 20 according to the present embodiment, in which the first distance D1 is shorter than the second distance D2, the light collection optical element 27 can efficiently capture the fluorescence YL having exited out of the wavelength converter 24 at a large angle of radiation. The light collection optical element 27 narrows the luminous flux width of the illumination light WL by collecting the illumination light WL containing the fluorescence YL.

The light source apparatus 20 according to the present embodiment thus outputs the illumination light WL collected by the light collection optical element 27. The illumination light WL outputted from the light source apparatus 20 enters the pickup system 34. The illumination light WL collected by the light collection optical element 27 and therefore having the narrowed luminous flux width satisfactorily enters the pickup system 34.

The light source apparatus 20 according to the present embodiment described above provides the following effects.

The light source apparatus 20 according to the present embodiment includes the plurality of laser light emitters 22 including the first laser light emitter 22a, which outputs the excitation light E having a blue wavelength band, the wavelength converter 24, which converts the excitation light E into the fluorescence YL having the yellow wavelength band different from the blue wavelength band, the base 21, which includes the first support part 210, which supports the plurality of laser light emitters 22, and the second support part 211, which supports the wavelength converter 24, the light transmissive member 25, which has the first surface 25a and the second surface 25b and is disposed at the side across the wavelength converter 24 from the base 21, and on the first surface 25a of which the excitation light E outputted from the plurality of laser light emitters 22 is incident, the reflectors 26, which are disposed at the second surface 25b of the light transmissive member 25 and include the first reflector 26a, which reflects the excitation light E outputted from the first laser light emitter 22a toward the wavelength converter 24, and the light collection optical element 27, which is disposed at the side facing the second surface 25b of the light transmissive member 25 and collects the illumination light WL having exited out of the wavelength converter 24 and passed through the light transmissive member 25. The first distance D1 along the optical axis 27C of the light collection optical element 27 between the wavelength converter 24 and the light collection optical element 27 is shorter than the second distance D2 along the optical axis 27C between the first laser emitter 22a and the light collection optical element 27.

The light source apparatus 20 according to the present embodiment, in which the light transmissive member 25 disposed between the wavelength converter 24 and the light collection optical element 27 suppresses spreading of the fluorescence YL, allows the light collection optical element 27 to efficiently capture the fluorescence YL.

Furthermore, in the light source apparatus 20 according to the present embodiment, in which the excitation light E reflected off the reflectors 26 disposed at the second surface 25b of the light transmissive member 25 enters the wavelength converter 24, the wavelength converter 24 can be disposed at a position closer to the light collection optical element 27 than the laser light emitters 22. The configuration in which the first distance D1 is shorter than the second distance D2 therefore allows the light collection optical element 27 to efficiently capture the fluorescence YL having exited out of the wavelength converter 24 at a large angle of radiation.

The light source apparatus 20 according to the present embodiment can therefore efficiently extract the fluorescence YL to generate bright illumination light WL.

Furthermore, the light source apparatus 20 according to the present embodiment can generate the white illumination light WL by itself without a separate blue light source, whereby the size of the configuration of the light source apparatus can be reduced.

The light source apparatus 20 according to the present embodiment further includes the collimator lenses 23, which are disposed between the laser light emitters 22 and light transmissive member 25 and parallelize the excitation light E outputted from the laser light emitters 22.

The configuration described above, in which the excitation light E is parallelized so that spreading of the excitation light E is suppressed, allows the excitation light E to efficiently enter the wavelength converter 24 even when the distance between the laser light emitters 22 and the wavelength converter 24 is increased. The wavelength converter 24 and the laser light emitters 22 can therefore be disposed at the base 21 with increased flexibility with the amount of lost components of the excitation light E suppressed.

Furthermore, increasing the distance between the laser light emitters 22 and the wavelength converter 24, which are heat sources in the light source apparatus 20, lowers the thermal density of the base 21. The temperatures of the laser light emitters 22 and the wavelength converter 24 can therefore be readily controlled, whereby, for example, the number of laser light emitters 22 can be increased in correspondence with the reduced amount of the thermal density to increase the intensity of the excitation light E.

In the light source apparatus 20 according to the present embodiment, the reflectors 26 are each formed of the dichroic mirror 126, which reflects the excitation light E and transmits the fluorescence YL.

The configuration described above prevents a loss of the fluorescence YL that occurs when the fluorescence YL is reflected off the reflectors 26.

In the light source apparatus 20 according to the present embodiment, the plurality of reflectors 26 are separate members and are spaced from each other.

According to the configuration described above, the reflectors 26 can be disposed at predetermined positions at the second surface 25b of the light transmissive member.

In the light source apparatus 20 according to the present embodiment, the reflectors 26 are each provided in correspondence with the region, of the second surface 25b of the light transmissive member 25, on which the excitation light E outputted from the corresponding laser light emitter 22 is incident.

In the present embodiment, the reflectors 26 each have a rectangular planar shape having the lengthwise dimension 26L and the widthwise dimension 26S. The excitation light E forms an elliptical irradiation spot SP on each of the reflectors 26. The laser light emitters 22 and the reflectors 26 corresponding to each other are so disposed that the major axis SP1 of each of the irradiation spots SP extends along the lengthwise dimension 26L of the reflector 26.

According to the configuration described above, in which the reflectors 26 are selectively disposed at the second surface 25b of the light transmissive member 25 at the positions where the excitation light E is incident (irradiation spots SP), the irradiation spots SP are unlikely to extend off the reflectors 26, whereby the excitation light E reflected off the reflectors 26 are allowed to efficiently enter the wavelength converter 24.

Furthermore, since the reflectors 26 are not disposed at the second surface 25b of the light transmissive member in the regions where the excitation light E is not incident, the excitation light E contained in the illumination light WL can be extracted toward the light collection optical element 27 via the gaps between the reflectors 26.

The loss of the excitation light E due to the reflectors 26 can therefore be reduced, whereby part of the excitation light E can be used as the illumination light WL.

The projector 1 according to the present embodiment described above provides the following effects.

The projector 1 according to the present embodiment includes the light source apparatus 20, the light modulators 4B, 4G, and 4R, which modulate the blue light LB, the green light LG, and the red light LR from the light source apparatus 20 in accordance with image information to form image light, and the projection optical apparatus 6, which projects the image light described above.

The projector 1 according to the present embodiment includes the light source apparatus 20, which is compact and generates the bright white illumination light WL, and can therefore be a compact projector that forms and projects a high-luminance image.

### Second Embodiment

The configuration of the light source apparatus according to a second embodiment of the present disclosure will be subsequently described. In the present embodiment, configurations or members common to those in the first embodiment have the same reference characters and will not be described in detail.

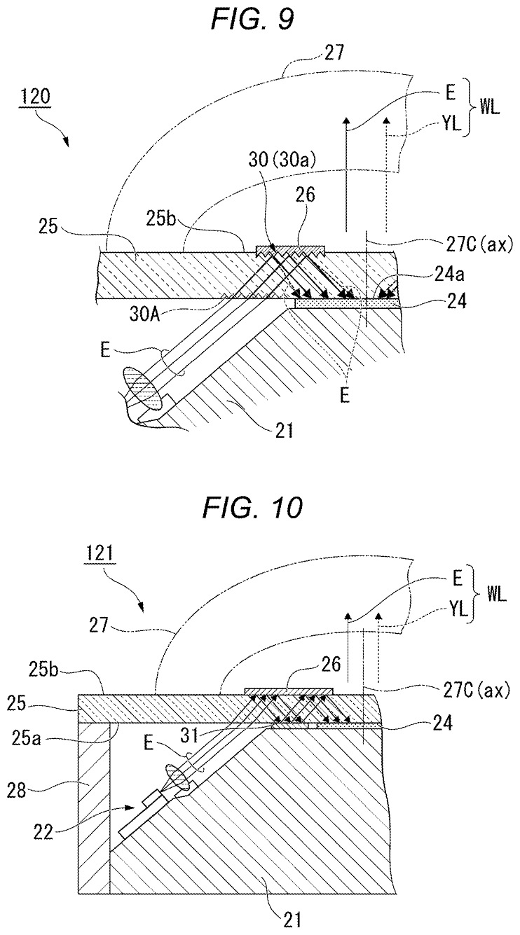

FIG. 9 is a cross-sectional view showing the configurations of key parts of the light source apparatus according to the present embodiment. FIG. 9 is a cross-sectional view corresponding to FIG. 4 in the first embodiment.

A light source apparatus 120 according to the present embodiment further includes diffusers 30, as shown in FIG. 9.

The diffusers 30 diffuse the excitation light E outputted from the laser light emitters 22. The diffusers 30 are each disposed in the optical path of the excitation light E from the light emission surface 220a of the corresponding laser light emitter 22 to the light incident surface 24a of the wavelength converter 24.

In the present embodiment, the diffusers 30 is formed at the second surface 25b of the light transmissive member 25, which is the surface facing the light collection optical element 27, in the regions where the reflectors 26 are disposed. The diffusers 30 are each formed of irregularities 30a formed at the second surface 25b. The irregularities 30a are formed, for example, by forming random irregularities at the second surface 25b, for example, through sandblasting, or by forming a pattern having an optical diffusion function, such as the function of a holographic diffuser, at the second surface 25b.

In the light source apparatus 120 according to the present embodiment, when the excitation light E outputted from the laser light emitters 22 is incident on the reflectors 26, the excitation light E travels via the irregularities 30a of the diffusers 30 and is diffused as indicated by the broken lines. The excitation light E diffused by the diffusers 30 thus has a uniform intensity distribution in the luminous flux cross-section, whereby the optical density of the irradiation spots formed by the excitation light E at the light incident surface 24a of the wavelength converter 24 can be homogenized. Local heat generation in the wavelength converter 24 is thus suppressed, whereby the fluorescence conversion efficiency can be enhanced, and the life of the wavelength converter 24 can be prolonged.

The present embodiment has been described with reference to the case where the diffusers 30 are formed at the second surface 25b of the light transmissive member 25, which is the surface where the reflectors 26 are disposed, but the positions where the diffusers 30 are formed are not limited to the positions described above.

For example, diffusers 30A may be formed in the regions, of the first surface 25a of the light transmissive member 25, where the excitation light E outputted from the laser light emitters 22 is incident, as indicated by the double-dashed line in FIG. 9. Instead, diffusers may each be a diffuser plate disposed in the optical path of the excitation light E between the corresponding laser light emitter 22 and the first surface 25a of the light transmissive member 25. The diffusers 30A at the first surface 25a and the diffusers 30 at the second surface 25b may both be formed.

### Third Embodiment

The configuration of the light source apparatus according to a third embodiment of the present disclosure will be subsequently described. In the present embodiment, configurations or members common to those in the first embodiment have the same reference characters and will not be described in detail.

FIG. 10 is a cross-sectional view showing key parts of the light source apparatus according to the present embodiment. FIG. 10 is a cross-sectional view corresponding to FIG. 4 in the first embodiment.

A light source apparatus 121 according to the present embodiment further includes counter reflectors (third reflectors) 31, as shown in FIG. 10.

The counter reflectors 31 are disposed at the side, of the light transmissive member 25, that faces the wavelength converter 24, each have a reflection surface, and reflect the excitation light E reflected off the reflectors 26 back thereto. The reflectors 26 reflect the excitation light E reflected off the counter reflectors 31 toward the wavelength converter 24. The counter reflectors 31 are each formed, for example, of a dielectric multilayer film or a metal film.

In the present embodiment, the counter reflectors 31 are provided at the first surface 25a of the light transmissive member 25 in the regions where the excitation light E is not incident and which face the reflectors 26 but do not interfere with the wavelength converter 24. The counter reflectors 31 are not necessarily formed at the first surface 25a of the light transmissive member, and may instead be formed at the second support part 211 of the base 21.

In the light source apparatus 121 according to the present embodiment, the excitation light E outputted from the laser light emitters 22 enters the wavelength converter 24 after the optical path of the excitation light E is deflected three times between the reflectors 26 and the counter reflectors 31. Increasing the number of times by which the optical path of the excitation light E is deflected can increase the distance between the wavelength converter 24 and the laser light emitters 22 and the distance between the laser light emitters 22 in directions perpendicular to the optical axis 27C of the light collection optical element 27. The thermal density of the base 21 is thus suppressed, whereby the wavelength conversion efficiency of the wavelength converter 24 can be improved and the life of the wavelength converter 24 can be prolonged. Furthermore, for example, the number of laser light emitters 22 can be increased in correspondence with the amount of reduced thermal density to increase the intensity of the excitation light E.

### Fourth Embodiment

The configuration of the light source apparatus according to a fourth embodiment of the present disclosure will be subsequently described. In the present embodiment, configurations or members common to those in the first embodiment have the same reference characters and will not be described in detail.

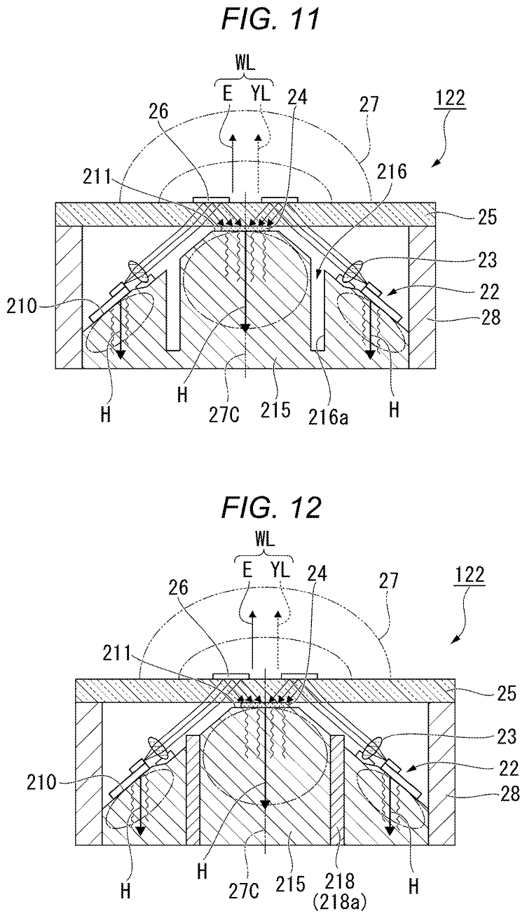

FIG. 11 is a cross-sectional view of the light source apparatus according to the present embodiment. FIG. 11 is a cross-sectional view corresponding to FIG. 4 in the first embodiment.

A light source apparatus 122 according to the present embodiment includes a base 215, the plurality of laser light emitters 22, the plurality of collimator lenses 23, the wavelength converter 24, the light transmissive member 25, the plurality of reflectors 26, the light collection optical element 27, and the side plate part 28, as shown in FIG. 11.

The base 215 in the present embodiment includes a heat insulation wall 216 formed between the first support part 210 and the second support part 211. The heat insulation wall 216 is a groove 216a formed in the base 21. In the plan view in the direction of the optical axis 27C of the light collection optical element 27, the heat insulation wall 216 is disposed so as to surround the second support part 211, which supports the wavelength converter 24.

The light source apparatus 122 according to the present embodiment, in which the groove 216a, which functions as the heat insulation wall 216, separates heat H generated by the laser light emitters 22 and heat H generated by the wavelength converter 24 from each other in the base 21, can suppress an increase in the thermal density of the base 21 due to the heat of the laser light emitters 22 and the heat of the wavelength converter 24 affecting each other. For example, suppressing an increase in the temperature of the wavelength converter 24 due to the heat of the laser light emitters 22 can improve the fluorescence conversion efficiency and reliability of the wavelength converter 24. On the other hand, suppressing an increase in the temperature of the laser light emitters 22 due to the heat of the wavelength converter 24 can improve the efficiency and reliability of the laser light emitters 22.

The present embodiment has been described with reference to the case where the groove 216a formed in the base 21 is used as the heat insulation wall 216 by way of example, but how to constitute the heat insulation wall is not limited thereto.

FIG. 12 shows the configuration of the heat insulation wall according to a variation.

A heat insulation wall 218 may be formed of a heat insulation material 218a buried in the base 21 between the first support part 210 and the second support part 211, as shown in FIG. 12.

According to the configuration of the present variation, the insulating material 218a buried in the base 21 can enhance the function of the heat insulation wall 218.

The present disclosure has been described with reference to the embodiments by way of example but is not necessarily limited to the embodiments described above, and a variety of changes can be made thereto to the extent that the changes do not depart from the intent of the present disclosure.

For example, the aforementioned embodiments have been described with reference to the case where the plurality of reflectors 26 are disposed at the second surface 25b of the light transmissive member 25, and a single reflector may be disposed at the second surface 25b of the light transmissive member 25.

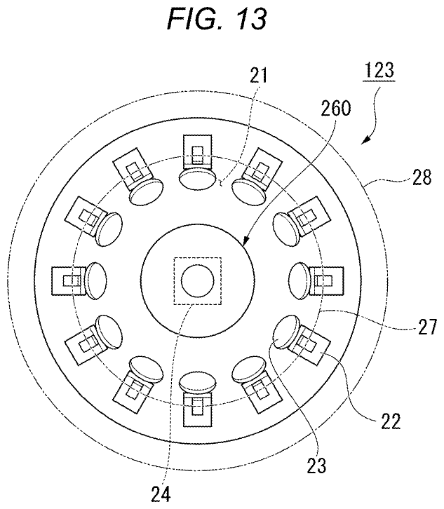

FIG. 13 shows the shape of the reflector according to a variation.

A reflector 260 shown in FIG. 13 has a ring-like planar shape. That is, in a light source apparatus 123 according to the present variation, the first reflector corresponding to the first laser light emitter 22a and the second reflector corresponding to the second laser light emitter 22b are integrated into a single member.

According to the configuration of the present variation, in which the reflector 260 is formed of a single member, even when the positions of the irradiation spots SP of the excitation light E are shifted due, for example, to an error in implementing the laser light emitters 22 at the base 21, the excitation light E is allowed to enter the wavelength converter 24 with no loss. When the ring-shaped reflector 260 is used, there is a risk that the amount of excitation light E that enters the light collection optical element 27 may decrease. In this case, for example, increasing the reflectance of the light incident surface 24a of the wavelength converter 24, changing the composition of the wavelength converter 24 to adjust the fluorescence conversion efficiency, or any other method allows compensation in the amount of excitation light E.

The light source apparatuses according to the aforementioned embodiments and variations have been described with reference to the case where the plurality of laser light emitters 22 are provided, but the number of laser light emitters 22 is not limited to a specific number, and the laser light emitters 22 may be formed only of the first light emitter 22a.

In the embodiments described above, the projector 1 including the three light modulators 4R, 4G, and 4B has been presented by way of example, and the present disclosure is also applicable to a projector that displays color video images via one light modulator. Furthermore, the light modulators are not limited to the liquid crystal panels described above and can instead, for example, be digital mirror devices.

In the embodiments described above, the light source apparatuses according to the present disclosure are each used in a projector by way of example, but not necessarily. The light source apparatuses according to the present disclosure may each be used as a lighting apparatus, such as a headlight of an automobile.

A light source apparatus according to an aspect of the present disclosure may have the configuration below.

The light source apparatus according to the aspect of the present disclosure includes a first laser light emitter that outputs first light having a first wavelength band, a wavelength converter that converts the first light into second light having a second wavelength band different from the first wavelength band, a base that includes a first support part that supports the first laser light emitter, and a second support part that supports the wavelength converter, a light transmissive member that has a first surface and a second surface that is opposite from the first surface and is disposed at the side across the wavelength converter from the base, and on the first surface of which the first light outputted from the first laser light emitter is incident, a first reflector that is disposed at the second surface of the light transmissive member and reflects the first light outputted from the first laser light emitter toward the wavelength converter, and a light collection optical element that is disposed at the side facing the second surface of the light transmissive member and collects light having exited out of the wavelength converter and passed through the light transmissive member, and a first distance along the optical axis of the light collection optical element between the wavelength converter and the light collection optical element is shorter than a second distance along the optical axis between the first laser light emitter and the light collection optical element.

The light source apparatus according to the aspect of the present disclosure may further include a diffuser that diffuses the first light, and the diffuser may be disposed in the optical path of the first light from a light emission surface of the first laser light emitter to a light incident surface of the wavelength converter.

In the light source apparatus according to the aspect of the present disclosure, the diffuser may be formed at the second surface of the light transmissive member in the region where the first reflector is disposed.

In the light source apparatus according to the aspect of the present disclosure, the first surface of the light transmissive member may face the wavelength converter, and the diffuser may be formed in the region, of the first surface of the light transmissive member, where the first light outputted from the first laser light emitter is incident.

The light source apparatus according to the aspect of the present disclosure may further include a third reflector that is disposed at the side, of the light transmissive member, that faces the wavelength converter, and reflect the first light reflected off the first reflector back to the first reflector and the first reflector may reflect the first light reflected off the third reflector toward the wavelength converter.

In the light source apparatus according to the aspect of the present disclosure, the base may have a heat insulation wall provided between the first and second support parts.

In the light source apparatus according to the aspect of the present disclosure, the heat insulation wall may be a groove formed in the base.

In the light source apparatus according to the aspect of the present disclosure, the heat insulation wall may be a heat insulation material buried in the base.

The light source apparatus according to the aspect of the present disclosure may further include a parallelizing lens that is disposed between the first laser light emitter and the light transmissive member and parallelizes the first light outputted from the first laser light emitter.

In the light source apparatus according to the aspect of the present disclosure, the first reflector may be formed of an optical element that reflects the first light and transmits the second light.

The light source apparatus according to the aspect of the present disclosure may further include a second laser light emitter that outputs the first light and a second reflector that is disposed at the second surface of the light transmissive member and reflects the first light outputted from the second laser light emitter toward the wavelength converter, and the first and second reflectors may be separate members and spaced from each other.

In the light source apparatus according to the aspect of the present disclosure, the first reflector may be provided in correspondence with the region, of the second surface of the light transmissive member, where the first light outputted from the first laser light emitter is incident, and the second reflector may be provided in correspondence with the region, of the second surface of the light transmissive member, where the first light outputted from the second laser light emitter is incident.

In the light source apparatus according to the aspect of the present disclosure, the first and second reflectors may each have a rectangular planar shape having a lengthwise dimension and a widthwise dimension. The first light outputted from the first laser light emitter may form an elliptical first irradiation spot on the first reflector. The first light outputted from the second laser light emitter may form an elliptical second irradiation spot on the second reflector. The first laser light emitter and the first reflectors may be so disposed that the major axis of the first irradiation spot extends along the lengthwise dimension of the first reflector. The second laser light emitter and the second reflectors may be so disposed that the major axis of the second irradiation spot extends along the lengthwise dimension of the second reflector.

The light source apparatus according to the aspect of the present disclosure may further include a second laser light emitter that outputs the first light and a second reflector that is disposed at the second surface of the light transmissive member and reflects the first light outputted from the second laser light emitter toward the wavelength converter, and the first and second reflectors may be integrated into a single member.

A projector according to another aspect of the present disclosure may have the configuration below.

The projector according to the other aspect of the present disclosure includes the light source apparatus according to the aspect of the present disclosure, a light modulator that modulates light from the light source apparatus, and a projection optical apparatus that projects the light modulated by the light modulator.

What is claimed is:

1. A light source apparatus comprising:
a first laser light emitter configured to emit first light having a first wavelength band;
a wavelength converter configured to convert the first light into second light having a second wavelength band different from the first wavelength band;
a base including a first support part that supports the first laser light emitter and a second support part that supports the wavelength converter;
a light transmissive member having a first surface and a second surface that is opposite from the first surface and disposed at a side opposite to the base with respect to the wavelength converter, the first light emitted from the first laser light emitter being incident on the first surface;
a first reflector disposed at the second surface of the light transmissive member and configured to reflect the first light emitted from the first laser light emitter toward the wavelength converter; and
a light collection optical element disposed at a second surface side of the light transmissive member and configured to collect light that is emitted from the wavelength converter and passes through the light transmissive member,
wherein a first distance along an optical axis of the light collection optical element between the wavelength converter and the light collection optical element is shorter than a second distance along the optical axis between the first laser light emitter and the light collection optical element.

2. The light source apparatus according to claim 1, further comprising
a diffuser configured to diffuse the first light,
wherein the diffuser is disposed in an optical path of the first light from a light emission surface of the first laser light emitter to a light incident surface of the wavelength converter.

3. The light source apparatus according to claim 2,
wherein the diffuser is formed at the second surface of the light transmissive member in a region where the first reflector is disposed.

4. The light source apparatus according to claim 2,
wherein the first surface of the light transmissive member faces the wavelength converter, and
the diffuser is formed at the first surface of the light transmissive member in a region where the first light emitted from the first laser light emitter is incident.

5. The light source apparatus according to claim 1, further comprising
a third reflector disposed at a wavelength converter side with respect to the light transmissive member and configured to reflect the first light reflected off the first reflector back to the first reflector,
wherein the first reflector reflects the first light reflected off the third reflector toward the wavelength converter.

6. The light source apparatus according to claim 1,
wherein the base has a heat insulation wall provided between the first and second support parts.

7. The light source apparatus according to claim 6,
wherein the heat insulation wall is a groove formed in the base.

8. The light source apparatus according to claim 6,
wherein the heat insulation wall is a heat insulation material buried in the base.

9. The light source apparatus according to claim 1, further comprising
a parallelizing lens disposed between the first laser light emitter and the light transmissive member and configured to parallelize the first light emitted from the first laser light emitter.

10. The light source apparatus according to claim 1,
wherein the first reflector is formed of an optical element that reflects the first light and transmits the second light.

11. The light source apparatus according to claim 1, further comprising:
a second laser light emitter configured to emit the first light; and
a second reflector disposed at the second surface of the light transmissive member and configured to reflect the first light emitted from the second laser light emitter toward the wavelength converter,
wherein the first and second reflectors are separate members and are spaced from each other.

12. The light source apparatus according to claim 11,
wherein the first reflector is provided in correspondence with a region, of the second surface of the light transmissive member, where the first light emitted from the first laser light emitter is incident, and
the second reflector is provided in correspondence with a region, of the second surface of the light transmissive member, where the first light emitted from the second laser light emitter is incident.

13. The light source apparatus according to claim 12,
wherein the first and second reflectors each have a rectangular planar shape having a lengthwise dimension and a widthwise dimension,
the first light emitted from the first laser light emitter forms an elliptical first irradiation spot on the first reflector,
the first light emitted from the second laser light emitter forms an elliptical second irradiation spot on the second reflector,
the first laser light emitter and the first reflectors are so disposed that a major axis of the first irradiation spot extends along the lengthwise dimension of the first reflector, and
the second laser light emitter and the second reflectors are so disposed that a major axis of the second irradiation spot extends along the lengthwise dimension of the second reflector.

14. The light source apparatus according to claim 1, further comprising:
a second laser light emitter configured to emit the first light; and
a second reflector disposed at the second surface of the light transmissive member and configured to reflect the first light emitted from the second laser light emitter toward the wavelength converter,
wherein the first and second reflectors are integrated into a single member.

15. A projector comprising:
the light source apparatus according to claim 1;
a light modulator configured to modulate light emitted from the light source apparatus; and
a projection optical apparatus configured to project the light modulated by the light modulator.
